(19) United States
(12) Patent Application Publication
(10) Pub. No.: US 2014/0270899 A1
(43) Pub. Date: Sep. 18, 2014

(54) MAGNETICALLY ACTUATED CAP LOCKING ASSEMBLY AND WRITING INSTRUMENT COMPRISING SAME

(71) Applicants: Leighton Davies-Smith, Founex (CH); David Martin, Glynde Nr Lewes (GB)

(72) Inventors: Leighton Davies-Smith, Founex (CH); David Martin, Glynde Nr Lewes (GB)

(21) Appl. No.: 13/838,264

(22) Filed: Mar. 15, 2013

(51) Int. Cl. B43K 23/12

(52) U.S. Cl. CPC B43K 23/12
USPC 401/195

(57) ABSTRACT

A writing instrument includes a magnetically actuated locking assembly for releasably securing a first component, such as a cap, to a second component, such as a barrel. The magnetically actuated locking assembly includes a first magnet and at least one second magnet, the magnetic fields of which actuate and release a mechanical lock between the first component and the second component.

### BACKGROUND

1. Field of the Invention

The invention generally relates to a writing instrument with a magnetically actuated locking assembly and more specifically to a writing instrument having a magnetically actuated locking assembly releasably securing a first component, such as a cap, to a component portion, such as a nose section of a barrel.

2. Related Technology

Conventional writing instruments typically have a cap or cover of some sort that protects the writing nib and helps to prevent ink from evaporating from the nib when the writing instrument is not being used. Often the cap is a separate component that is releasably secured to a nose section of a barrel of the writing instrument. Similarly, many conventional writing instruments have a rear section of the barrel that is releasably secured to the nose section of the barrel to give a consumer access to a replaceable ink refill cartridge within the barrel.

Generally, known writing instruments use one of two different connection mechanisms to releasably secure the cap to the nose section and/or to secure the nose section of the barrel to the rear section of the barrel.

First, some known writing instruments use a threaded connection where, for example, the cap is screwed onto the nose section. This type of threaded connection, while being secure, can be somewhat cumbersome for a consumer to use. Initially, the consumer must align the cap with the nose section and then the cap must be rotated through several revolutions to a secured position. The reverse operation is needed to remove the cap from the nose section. This threaded connection is therefore somewhat time consuming and inefficient to use, especially when the cap needs to be secured and removed from the nose section repeatedly in a short period of time. Additionally, the threaded connection can easily become damaged if the threads are improperly aligned prior to and/or during rotation.

A second type of connection is an interference connection that uses offset ridges, usually a first ridge on the outside of the nose section and a second ridge on the inside of the cap. A consumer aligns the cap and the nose section and pushes the cap until the second ridge slides over the first ridge to provide a secured position between the cap and the nose section. This type of connection is often called a “snap-fit” connection. While this type of connection is quicker to use, it is also more susceptible to inadvertent dislodgement as it is inherently weaker than the threaded connection. Additionally, this type of connection is more prone to weakening (due to material loss from repeated frictional engagement) or warping over time.

### BRIEF DESCRIPTION OF THE DRAWINGS

Further features and advantages of the invention can be gathered from the claims, the following description, and the attached diagrammatic drawings, wherein:

FIG. 1 is a longitudinal cross-sectional view of a first embodiment of a writing instrument having a magnetically actuated locking assembly between a cap and a nose portion of a barrel;

FIG. 2 is a close-up longitudinal cross-sectional view of a nose section of the barrel of the writing instrument of FIG. 1;

FIG. 3 is a lateral cross-sectional view of the barrel of the writing instrument of FIG. 1,

FIG. 4A is longitudinal cross-sectional view of a barrel magnet of the barrel of the writing instrument of FIG. 1;

FIG. 4B is a side view of the barrel magnet of FIG. 4A;

FIG. 4C is a lateral cross-sectional view of the barrel magnet of FIG. 4A;

FIG. 5A is longitudinal cross-sectional view of a cap of the writing instrument of FIG. 1;

FIG. 5B is a longitudinal cross-sectional view of a cap magnet of the cap of FIG. 5;

FIG. 5C is a lateral cross-sectional view of the cap magnet of the cap of FIG. 5;

FIG. 6A is a longitudinal cross-sectional view of the barrel magnet of FIG. 4A and the cap magnet of FIG. 5B, the barrel magnet being partially inserted into the cap magnet;

FIG. 6B is a longitudinal cross-sectional view of the barrel magnet of FIG. 4A and the cap magnet of FIG. 5B, the barrel magnet being fully inserted into the cap magnet;

FIG. 6C is a lateral cross-sectional view of the cap magnet and the barrel magnet of FIG. 6B;

FIG. 7A is a longitudinal cross-sectional view of a portion of the cap and a portion of the barrel of the writing instrument of FIG. 1, with the barrel being partially inserted into the cap, and with the magnetically actuated locking mechanism being in an unlocked state;

FIG. 7B is a lateral cross-sectional view of the barrel taken along line 7B-7B of FIG. 7A;

FIG. 8A is a longitudinal cross-sectional view of a portion of the cap and a portion of the barrel of the writing instrument of FIG. 1, with the barrel being fully inserted into the cap, and with the magnetically actuated locking mechanism being in a locked state;

FIG. 8B is a lateral cross-sectional view of the barrel taken along line 8B-8B of FIG. 8A;

FIG. 9A is a longitudinal cross-sectional view of a portion of the cap and a portion of the barrel of the writing instrument of FIG. 1, with the barrel being fully inserted into the cap, and with the magnetically actuated locking mechanism being in an unlocked state;

FIG. 9B is a lateral cross-sectional view of the barrel taken along line 9B-9B of FIG. 9A;

FIG. 9C is a longitudinal cross-sectional view of a portion of the cap and a portion of the barrel of the writing instrument of FIG. 1, with the barrel being partially withdrawn from the cap, and with the magnetically actuated locking mechanism being in an unlocked state;

FIG. 10 is a side view of a cap and a portion of a barrel of a second embodiment of a writing instrument including a magnetically actuated locking assembly;

FIG. 11 is a longitudinal cross-sectional view of the cap and the barrel of FIG. 10, the cap being disposed on one end of the barrel and the magnetically actuated locking assembly being in a locked position;

FIG. 12 is a longitudinal cross-sectional view of the cap and the barrel of FIG. 10, the cap being disposed on one end of the barrel and the magnetically actuated locking assembly being in an unlocked position;

FIG. 13 is a schematic perspective view of a barrel magnet and a collet having a plurality of cap magnets of the magnetically actuated locking assembly;

FIG. 14A is a schematic perspective view of a barrel magnet and a collet having a plurality of cap magnets of the magnetically actuated locking assembly, the barrel magnet being positioned to maintain the cap magnets in an unlocked position;

FIG. 14B is a schematic perspective view of a barrel magnet and a collet having a plurality of cap magnets of the magnetically actuated locking assembly, the barrel magnet being twisted relative to the cap magnets to actuate the cap magnets into a locked position;

FIG. 14C is a schematic perspective view of a barrel magnet and a collet having a plurality of cap magnets of the magnetically actuated locking assembly, the barrel magnet being aligned relative to the cap magnets to maintain the cap magnets into a locked position;

FIG. 15 is a schematic perspective view of a barrel magnet and a collet having a plurality of cap magnets of the magnetically actuated locking assembly, the barrel magnet being twisted relative to the cap magnets to actuate the cap magnets into the unlocked position;

FIGS. 16A and 16B are cross-sectional views of an alternative embodiment of a magnetically actuated locking assembly, the magnetically actuated locking assembly including a cap pull-off load override mechanism, the override mechanism being in a locked position in FIG. 16A and in an override or unlocked position in FIG. 16B;

FIG. 17 is a partial perspective view of a portion of a barrel of a third embodiment of a writing instrument including a magnetically actuated locking assembly, the magnetically actuated locking assembly releasably securing a nose section of the barrel to a rear section of the barrel;

FIG. 18 is a perspective view of a locking ring with locking arms of the magnetically actuated locking assembly of FIG. 17; and

FIGS. 19A-19D are sequential side cross-sectional views of a locking operation and an unlocking operation of the magnetically actuated locking assembly of FIG. 17.

### DETAILED DESCRIPTION

The disclosed writing instrument advantageously includes a magnetically actuated locking assembly between a first component, such as a cap, and a second component, such as nose section of a barrel, the magnetically actuated locking assembly mechanically releasably securing the first component to the second component when the first component is disposed on the second component and the second component and the first component are in locking alignment. The magnetically actuated locking assembly releases the mechanical lock when the first component and the second component are in a released alignment. The writing instrument relies on magnetic field attraction for a motive force to pull or twist the first component into a secured position with respect to the second component and to actuate a mechanical lock. The magnetic field attraction also provides continuing motive force to maintain the mechanical lock in a secured position. To release the mechanical lock, the magnetic field attraction must be overcome by twisting the first component relative to the second component. Thus writing instrument described herein advantageously provides a closure system that includes a mechanical lock connection having a tactile sensation that indicates a secured position. The mechanical lock connection also allows the first component to be quickly secured to, or released from, the second component. In some embodiments, the first component may be the nose section of the barrel and the second component may be a rear section of the barrel.

A fountain pen 10 is exemplified in some of the drawings and marker 110 is exemplified in other drawings, however, other writing instruments including, but not limited to markers, highlighters, ball pens, felt tip pens, and other fluid application devices including, but not limited to, correction fluid applicators and paint applicators could also be made in accordance with the teachings of the disclosure by selection of appropriate components. Similarly, other types of tools such as utility blades, screw drivers, punches, flashlights, etc., may be constructed in accordance with the teachings of the disclosure by substituting a tool for the illustrated writing nib.

Turning now to FIG. 1, the fountain pen 10 comprises a first component, such as a cap 20, and a second component, such as a nose section 12 of a barrel 21, the nose section 12 includes an opening 14 at one end thereof through which a writing nib 16 extends. The nose section 12 is connected to a barrel housing portion, such as a rear barrel section 18, which houses an ink reservoir 19 that is capable of holding a supply of ink for delivery to the writing nib 16 (i.e., the ink reservoir can be in fluid communication with the nib). The cap 20 may be releasably connected to the nose section 12 to cover the nib 16 when the nib 16 is not being used, so as to prevent ink from evaporating from the nib 16 and/or to prevent the nib 16 from becoming damaged. The cap 20 and nose section 12 include a magnetically actuated locking assembly 22 that releasably secures the cap 20 to the nose section 12, which facilitates and provides easy access to the writing nib 16.

Turning now to FIG. 2, the nose section 12 of the barrel 21 is illustrated in more detail. More specifically, the nose section 12 may include a ferrule portion 24 and an ink delivery assembly 26. The ink delivery assembly 26 includes the writing nib 16, which terminates at a writing point 28. One or more ink delivery channels 30 fluidly connect the writing point 28 to the ink reservoir 19.

The magnetically actuated locking assembly 22 comprises a nose magnet 32 located on the ferrule portion 24 and a plurality of pin magnets 36 located rearward of the nose magnet 32, towards the rear barrel section 18. The pin magnets 36 are radially slidable relative to the barrel 21. In other words, the pin magnets 36 may slide outward, away from a longitudinal axis A of the barrel 21 to a locked position in which a portion of the pin magnets 36 extends outward beyond an outer surface 37 of the nose magnet 32, and inward, towards the longitudinal axis A to a released position in which the pin magnets 36 are recessed so that an outer surface 38 of the pin magnets is even with, or below (i.e., radially inward of) the outer surface 37 of the nose magnet 32.

As illustrated in FIG. 3, the pin magnets 36 are magnetically oriented so that magnetic poles of adjacent pin magnets 36 are opposite of one another. For example, a first pin magnet 36a may have a magnetic north pole 40a directed outward, away from the longitudinal axis A while a magnetic south pole 41a is directed inward, toward the longitudinal axis A. A second pin magnet 36b may have a magnetic north pole 40b directed inward, toward the longitudinal axis A and a magnetic south pole 41b directed outward, away from the longitudinal axis A. When the pin magnets are configured as described above, a magnetic attraction is generated between the inward magnetic poles (e.g., the magnetic south pole 41a and the magnetic north pole 40b) that biases the pin magnets 36 towards the retracted or released position, which is illustrated in FIGS. 2 and 3.

The pin magnets 36 may be disposed in a plurality of nose magnet openings 46 that are distributed circumferentially about the nose section 12. The nose magnet openings 46 are sized and shaped to receive the pin magnets 36. In one embodiment, the pin magnets 36, and the nose magnet openings 46, may have a circular cross-sectional shape. In other embodiments, the pin magnets 36, and the nose magnet openings 46 may have square or rectangular cross-sectional shapes. Regardless, the nose magnet openings 46 are sized and shaped to receive the pin magnets 36 in a radially slidable relationship.

A shell liner 48 is located between the pin magnets 36 and the nose magnet 32. The shell liner 48 acts as a bearing support for the pin magnets 36 as the pin magnets 36 slide radially. The shell liner 48 provides a close fitting sliding housing support that is capable of withstanding pull-off cap loads. The shell liner 48 could be made of plastic, brass, or non-magnetic stainless steel, for example, or any other material that is strong enough to withstand cap pull-off loads. Sliding faces of the shell liner 48 should be made of a different material than the sliding faces of the pin magnets 36 to enhance slidability of the cap magnets 36.

A stop collar 50 may be disposed proximate a first or inner end 52 of the pin magnets 36. The stop collar 50 limits radial movement of the pin magnet 36 in an outward direction. More specifically, when the pin magnet 36 moves radially outward, eventually the stop collar 50 will contact the shell liner 48 and/or the nose magnet 32 and/or the barrel housing portion 18, which causes radial outward movement of the pin magnets 36 to stop. Radial inward movement of the pin magnets 36 is limited by the ink delivery assembly 26 in a similar fashion. The stop collar 50 provides a sliding bearing face for the pin magnets 36. In one embodiment, the stop collar 50 may be made of a non-magnetic material, such as brass or stainless steel.

While four pin magnets are illustrated in the embodiment of FIGS. 1-9, more or fewer pin magnets 36 may be used in other embodiments. For example, 2, 3, 5, 6, 7, or more pin magnets may be used, preferably an even number so that the magnetic poles 40, 41 of the pin magnets 36 may be oriented as discussed above. In an alternative embodiment, a central magnet (not shown), or a ferro-magnetic element, may be disposed within the barrel 21, along the longitudinal axis A, the pin magnets 36 being magnetically attracted to the central magnet, or to the ferro-magnetic element, causing the pin magnets 36 to retract when the cap 20 is not connected to the barrel 21. In this embodiment, an odd number of pin magnets 36 may be used and adjacent pin magnets 36 may have similar magnetic pole orientations (e.g., adjacent pin magnets 36 may have magnetic north poles that are both oriented outward or are both oriented inward).

FIGS. 4A-4C illustrate the nose magnet 32 in more detail. The outer surface 37 of the nose magnet 32 is tapered. An inner bore 54 includes a first portion 54a having a first diameter, and a second portion 54b having a second, larger diameter. The nose magnet openings 46 are located in the second portion 54b. In one embodiment, the nose magnet 32 may be a four pole diametrically polarized ring magnet, as illustrated in FIG. 4C. More specifically, the nose magnet 32 may include two magnetic north poles that are diametrically opposed to one another and two magnetic south poles that are diametrically opposed to one another.

Turning now to FIGS. 5A-5C, the cap 20 includes a cap body 60 and a cap magnet 62. The cap magnet 62 includes a central bore 64 having a first portion 66 including a tapered inner surface 68 and a second portion 70 having a substantially constant diameter. The tapered inner surface 68 is sized and shaped to receive the tapered outer surface 37 of the nose magnet 32. The cap magnet 62 further includes an annular recess 72 that is sized and shaped to receive at least a portion of a pin magnet 36. In one embodiment, the annular recess 72 is a continuous recess extending around an inner circumference of the cap magnet 62. In other embodiments, the annular recess 72 may be made up of a plurality of discrete recesses, each sized to receive a portion of a single pin magnet 36. The cap 20 also includes a cap trim 74 that cooperates with the barrel housing portion 18 to seal the barrel 21 to the cap 20. The cap trim 74 also provides a strong surface to the annular recess 72 that withstands cap pull-off loads. The cap trim 74 may be manufactured from brass or stainless steel, or other similar material that provides a hard edge for the pin magnets 36 to stop against when the pin magnets 36 are in the locked position.

Similar to the nose magnet 32, the cap magnet 62 may take the form of a four pole diametrically opposed ring magnet, as illustrated in FIG. 5C. More specifically, in one embodiment, the cap magnet 62 may include two magnetic north poles that are diametrically opposed to one another and two magnetic south poles that are diametrically opposed to one another.

FIGS. 6A-6C illustrate the relationship between the cap magnet 62 and the nose magnet 32 during a capping operation of the writing instrument. Initially, the nose magnet 32 is axially aligned with the cap magnet 62. As the cap magnet 62 is moved towards the nose magnet 32 (or vice versa), magnetic attraction between opposite poles of the cap magnet 62 and the nose magnet 32 urge the cap magnet 62 in a longitudinal direction towards the nose magnet 32 (or vice versa). Thus, a longitudinal attractive force created by the magnets 32, 62, aids in capping of the writing instrument 10. Additionally, a twisting force is created between respective opposite poles of the cap magnet 62 and the nose magnet 32. As illustrated in FIG. 6C, north poles of the cap magnet 62 are attracted to south poles of the nose magnet 32 and vice versa, thereby urging the cap magnet 62 into magnetic alignment with the nose magnet 32.

FIGS. 7A and 7B illustrate a portion of the barrel 21 and a portion of the cap 20 at a beginning of the capping operation described above with respect to FIGS. 6A-6C. Initially, nose section 12 (and the nose magnet 32) is partially inserted into the cap 20. The pin magnets 36, remaining outside of the cap 20, are in a retracted position due to the mutual magnetic attractive forces between the pin magnets 36 described above. The longitudinal and twisting forces generated between the nose magnet 32 and the cap magnet 62 urge the cap 20 into radial alignment with the barrel 21 and simultaneously urge the cap 20 further onto the barrel 12.

FIGS. 8A and 8B illustrate a capped and locked configuration of the magnetically actuated locking assembly 22. The nose section 12 of the barrel 21 is fully inserted into the cap 20. Magnetic attraction between the pin magnets 36 and the cap magnet 62 (which is greater than the magnetic attraction between the pin magnets 36 themselves) causes the pin magnets 36 to move radially outward, at least partially into the annular recess 72. The pin magnets 36 move radially outward until the stop collar 50 contacts the shell liner 48. Once the pin magnets 36 are engaged with the annular recess 72, the cap 20 is mechanically locked on the barrel 21. Additionally, the magnetic attraction between the pin magnets 36 and the cap magnet 62 maintains the pin magnets 36 in the radially extended and locked position.

FIGS. 9A and 9B illustrate a first step in an unlocking procedure for the magnetically actuated locking assembly 22. The barrel 21 in FIGS. 9A and 9B is rotated out of magnetic alignment with the cap 20. More specifically, the barrel 21 is rotated until outer magnetic poles of the pin magnets 36 are located proximate like poles on the cap magnet 20. For example, an outer north magnetic pole 40a of a first pin magnet 36a is located proximate a magnetic north pole 80 of the cap magnet 62. Similarly, a magnetic south pole 41b of a second pin magnet 36b is located proximate a magnetic south pole 81 of the cap magnet 62. The like magnetic poles (e.g., the outer magnetic north pole 40a and the magnetic north pole 80 of the cap magnet 62) produce a repelling magnetic force that urges the pin magnets 36 radially inward to a retracted position. As a result, the magnetically actuated locking assembly 22 releases the cap 20 from a locked position on the barrel 21. If the barrel 21 were subsequently twisted relative to the cap 20, or vice versa, until the outer poles of the pin magnets 36 were located proximate opposite poles of the cap magnet 62, the pin magnets 36 would be urged radially outward into the locked position once again.

FIG. 9C illustrates the barrel 21 being removed from the cap 20. Once the pin magnets 36 are removed from the cap 20 (and the cap magnet 62 no longer magnetically biases the pin magnets 36 radially inward), the pin magnets 36 are maintained in the radially retracted position by the mutual magnetic attraction between inner magnetic poles of the pin magnets 36, as described above.

Turning now to FIGS. 10 and 11, a writing instrument in the form of a marker 110 comprises a first component, for example a cap 20, and a second component, for example a nose section 112 of a barrel 121, the nose section 112 having an opening 114 at one end thereof through which a writing nib 116 extends. The nose section 112 is connected to a barrel housing portion 118, which houses an ink reservoir 119 that is capable of holding a supply of ink for delivery to the writing nib 116 (i.e., the ink reservoir can be in fluid communication with the nib). The cap 120 may be releasably connected to the nose section 112 to cover the nib 116 when the nib 116 is not being used, so as to prevent ink from evaporating from the nib 116 and/or to prevent the nib 116 from becoming damaged. The cap 120 and the nose section 112 include a magnetically actuated locking assembly 122 that releasably secures the cap 120 to the nose section 112, which facilitates and provides easy access to the writing nib 116.

The nose section 112 may include a ferrule portion 124 and an ink delivery assembly 126. The ink delivery assembly 126 includes the writing nib 116, which terminates at a writing point 128. One or more ink delivery channels 130 may fluidly connect the writing point 128 to the ink reservoir 119. In some embodiments, the writing nib 116 may comprise an extruded plastic tube.

The magnetically actuated locking assembly 122 comprises a nose magnet 132 located on the ferrule portion 124 and a plurality of cap magnets 136 disposed within a bore in the cap 120. The cap magnets 136 are pivotably connected to the cap 120. In other words, the cap magnets 136 may pivot inward, towards a longitudinal axis A of the barrel 121 to a locked position in which a locking mechanism 190, operatively connected to one or more of the cap magnets 136, extends inward into an annular recess 191 on the ferrule portion 124.

Referring now to FIG. 12, the cap magnets 136 are also pivotable away from the longitudinal axis A until the locking mechanism 190 is retracted out of the annular recess 191. In one embodiment, the locking mechanism 190 takes the form of a clasp. In other embodiments, the locking mechanism 190 may take the form of a hook, a pin, pawl, a spring finger form, an elastic plastic element, or a post. The locking mechanism 190 may be designed to provide component failure safety overload protection (e.g., a fail-safe capability). In one embodiment, the locking mechanism 190 may include a hook 196 having a curved surface 197, as illustrated in FIGS. 16A and 16B. The curved surface 197 may take the form of a partially or completely closed loop 198. When the locking mechanism 190 is engaged, and a cap pull-off load remains below a predetermined threshold, the hook 196 remains engaged with the annular recess 191, thereby securing the cap 120 to the barrel 121. When a cap pull-off load exceeds the predetermined threshold, the curved surface 197 rides radially outward, over a lip 199 of the annular recess 191, thereby releasing the cap 120 from the barrel 121. In this manner, the locking mechanism 190 prevents overload of the hook 196 and/or damage to the hook and to the annular recess 191. The predetermined threshold is preferably greater than about 2 kg, more preferably between 2 kg and 5 kg, and even more preferably between 2 kg and 4 kg. The upper end of the predetermined threshold range would be determined by a failure strength of the locking mechanism 190.

As illustrated in FIG. 13, the cap magnets 136 are magnetically oriented so that magnetic poles of adjacent cap magnets 136 are opposite of one another. For example, a first cap magnet 136a may have a magnetic north pole 140a directed inward, towards the longitudinal axis A while a second cap magnet 136b may have a magnetic south pole 141b directed inward, towards the longitudinal axis A.

The cap magnets 136 may be disposed in a collet 192, for example a four fingered collet, having a plurality of fingers 193 that are distributed circumferentially within the cap 120. In some embodiments, the collet 192 may be formed from pressed steel. In other embodiments, the collet 192 may be formed from carbon steel, martensitic stainless steel, beryllium copper, non-ferrous materials, engineering plastics, or any other material that has a fatigue strength that will support a high number of cap removal cycles. The fingers 193 may be connected to an anchor portion 194 via a living hinge 195, for example. In other embodiments other types of hinged connections may be used as long as the result is a pivotable connection between the cap magnets 136 and the cap 120. The nose magnet 132 may be four pole diametrically polarized ring magnet, as illustrated in FIG. 13 and as described above, having two magnetic north poles 132a oriented diametrically opposite of one another and two magnetic south poles 132b oriented diametrically opposite of one another.

When the north poles 132a of the nose magnet 132 are longitudinally aligned with cap magnets 136 having north poles 136b oriented inwardly, a repelling force is generated that biases the cap magnets 136, and thus the locking mechanisms 190, outward, away from the nose magnet 132 to an unlocked or released position, as illustrated in FIG. 14A. However, the north poles 132a of the nose magnet and the inwardly oriented south poles 136a of the cap magnets 136 generate a longitudinal attractive force in the direction of the longitudinal axis A and a twisting force that biases the nose magnet 132 and the cap magnets 136 into an orientation in which opposing magnetic poles are longitudinally aligned, as illustrated in FIG. 14B, similar to the longitudinal and twisting forces generated by the nose magnet 32 and the cap magnet 62 of the embodiment of FIGS. 1-9.

Once the magnetic north poles 132a of the nose magnet 132 are longitudinally aligned with the magnetic south poles 136a of the cap magnets 136, the cap magnets 136 pivot inwardly, towards the longitudinal axis A and the locking mechanisms 190 eventually become disposed within the annular recess 191, which locks the cap 120 on the barrel 121, as illustrated in FIGS. 11 and 14C. When the locking mechanisms 190 are disposed within the annular recess 191, further relative longitudinal movement between the cap magnets 136 and the nose magnet 132 is prevented and thus, the cap 120 is locked on the barrel 121.

To release the locking mechanism 122, the nose magnet 132 is twisted relative to the cap magnets 136 until the north poles 132a of the nose magnet 132 are longitudinally aligned with inwardly facing north poles 136b of the cap magnets 136, as illustrated in FIG. 15, which generates a magnetic repelling force, thereby causing the cap magnets 136 to pivot radially outward, away from the longitudinal axis A, thereby disengaging the locking mechanisms 190 from the annular recess 191.

Turning now to FIGS. 17-19, an alternate embodiment of a writing instrument 210 having a magnetically actuated locking assembly 222 includes a first component, for example a nose section 212 of a barrel 221, and a second component, for example a rear section 218 of a barrel 221. The rear section 218 includes a central chamber to house an ink reservoir 219. The nose section 212 is releasably connected to the rear section 218, which provides access to the ink reservoir 219. The nose section 212 and the rear section 218 may include the magnetically actuated locking assembly 222, which releasably secures the nose section 212 to the rear section 221, thereby facilitating and providing easy access to the ink reservoir 219. The magnetically actuated locking assembly 222 includes a nose magnet 201 located on the nose section 212, a rear magnet 202 located on the rear section 218, and a locking ring 203 also located on the rear section 218. In other embodiments, the elements described may reversed. For example, in other embodiments the locking ring 203 may be located on the nose section 212 rather than the rear section 218.

The locking ring 203 includes at least one locking arm 204, and in the embodiment of FIGS. 17-19, two locking arms 204 that are oriented circumferentially opposite of one another. The at least one locking arm 204 is flexible radially outward, away from a longitudinal axis of the writing instrument 210. A sheath 206 surrounds the chamber and the sheath 206 includes at least one longitudinal channel 207 to accommodate radial movement of the at least one locking arm 204, and an annular ring recess 208 to accommodate the locking ring 203. A distal end of each locking arm 204 includes an arm magnet 205.

The arm magnets 205 may have magnetic poles that are oriented opposite of one another. For example, one arm magnet 205 may have a magnetic north pole oriented radially outward and a magnetic south pole oriented magnetically inward while another arm magnet 205 may have a magnetic north pole oriented radially inward and a magnetic south pole oriented magnetically outward, or vice versa, as long as the arm magnets 205 have their magnetic poles oriented to produce the desired repelling and attracting forces relative to the nose magnet 201, as described below.

When releasably connecting the nose section 212 to the rear section 218, the nose section 212 and the rear section 218 are first aligned longitudinally with one another, as illustrated in FIG. 19A. The nose magnet 201 and the rear magnet 202 will produce relative twisting and attracting forces as the nose section 212 is moved closer to the rear section 218, due to the natural magnetic affinity between the magnetic north poles and the magnetic south poles. As the nose section 212 approaches the rear section 218, the arm magnets 205 begin to produce a repelling magnetic force with the nose magnet 201 due to the like magnetic poles being in close proximity to one another. This repelling force causes the flexible locking arms 204 to deflect radially outward, away from the longitudinal axis of the writing instrument. The radial deflection allows the arm magnets 205 to clear the nose magnet 201, as illustrated in FIG. 19B.

Once the arm magnets 205 are clear of the nose magnet 201, the repelling force will begin to decrease and the natural bias of the locking arms 204 will move the arm magnets 205 radially inward into an annular channel 209 formed in front of the nose magnet 201. The arm magnets 205 now mechanically lock the rear section 218 to the nose section 212, as illustrated in FIG. 19C. Additionally, the nose magnet 201 and the rear magnet 202 are magnetically oriented to produce an attracting force, which aids the mechanical connection.

To release the magnetically actuated locking assembly, the nose section 212 is twisted relative to the rear section 218 until like magnetic poles of the nose magnet 201 and the rear magnet 202 are adjacent one another, which will produce a repelling force. Additionally, a repelling force will be generated between the arm magnets 205 and the nose magnet 201, which will cause the flexible locking arm to move radially outward so that the arm magnets 205 are radially clear of the nose magnet 201. In this configuration, the magnetically actuated locking assembly 222 is released and the nose section 212 may be separated from the rear section 218, as illustrated in FIG. 19D.

Any suitable magnet may be used to provide the cap magnets 62, 136 and/or the nose magnets 32, 132, 201 and/or the rear magnets 202. In one embodiment the magnets may comprise neodymium iron boron disc super magnets having a field strength of approximately 400 g. In other embodiments, the magnets may comprise AlNiCo magnets. In other embodiments, various combinations of disc magnets may be arranged to produce an initial repulsive force followed by a twist-attraction, as described above. In some embodiments, the magnets may comprise neodymium iron born disc magnets, ferrite magnets, rare earth magnets, such as Samarium-cobalt and Alnico, or magnetic alloys.

In yet other embodiments, the cap magnets 62, 136, the nose magnets 32, 132, 201, and/or the rear magnets 202 may comprise diametrically polarized ring super magnets, which can produce either a repulsive or attractive force when a pair of such magnets is brought together depending on relative orientations of the respective north and south poles, as discussed above. Of course, other magnets can also be positioned to produce a repulsive force when the cap 20, 120 is properly aligned with the nose section 12, 112, which transitions to a net attractive force that results in twisting of the cap 20, 120 relative to the nose section 12, 112.

In yet other embodiments the cap magnets 62, 136, the nose magnets 32, 132, 201, and/or the rear magnets 202 may comprise a magnetic plastic resin. For example, the plastic resin can be infused with magnetic material and then subjected to a magnetic field before the resin sets in order to orient particles of the magnetic material in the same direction, thereby imparting magnetic properties to the plastic resin.

In the disclosed embodiments, the magnetic attractions are used to provide a seating force; however, the magnetic attractions are not solely relied upon for a connecting force between cap and nose section, but rather a mechanically actuated lock provides a locking force.

The disclosure is not limited to a fountain pen or a marker. The disclosure could be applied to virtually any writing instrument or tool, such as utility blades, flashlights, screw drivers, or other similar instruments. The features of the invention disclosed in the description, drawings and claims can be individually or in various combinations for the implementation of the different embodiments of the invention.

1. A writing instrument including a magnetically actuated locking assembly for releasably securing a first component to a second component, the writing instrument comprising:
a barrel body, the barrel body having a nose section;
a barrel magnet disposed proximate the nose section;
a cap releasably attached to the nose section, the cap having a cap opening at one end;
a cap magnet disposed proximate the cap opening; and
at least one pin magnet disposed on the barrel body, the pin magnet being radially slidable relative to a longitudinal axis of the barrel body,
wherein the barrel magnet and the cap magnet are magnetically attracted to one another to produce both a longitudinal force that urges the cap in a longitudinal direction along the longitudinal axis towards the nose section, and a radial twisting force that urges the cap to twist towards a locked position, and
wherein the pin magnets are attracted to the cap magnet when the cap magnet is oriented in the locked position, which causes the pin magnets to slide radially outward towards a locked configuration and the pin magnets are repelled from the cap magnet when the cap magnet is oriented in a released position, which causes the pin magnets to slide radially inward towards an unlocked retracted configuration.

2. The writing instrument of claim 1, further comprising four pin magnets.

3. The writing instrument of claim 2, wherein each pin magnet is magnetically oriented opposite of an adjacent pin magnet so that the pin magnets urge one another towards the unlocked retracted configuration when the cap is not disposed on the barrel.

4. The writing instrument of claim 1, wherein the barrel magnet is a ring magnet having two north poles located circumferentially opposite of one another and two south poles located circumferentially opposite of one another.

5. The writing instrument of claim 1, wherein the cap magnet is a ring magnet having two north poles located circumferentially opposite of one another and two south poles located circumferentially opposite of one another.

6. The writing instrument of claim 1, wherein the at least one pin magnet includes a stop collar that limits radial outward movement of the pin magnet.

7. The writing instrument of claim 1, wherein the barrel magnet includes an opening sized and shaped to receive the at least one pin magnet.

8. The writing instrument of claim 1, wherein the barrel body includes a plurality of openings disposed around a circumference of the barrel body, proximate the nose section, the plurality of openings being sized and shaped to receive a plurality of pin magnets.

9. The writing instrument of claim 1, wherein the at least one pin magnet comprises a neodymium iron boron disc magnet.

10. The writing instrument of claim 1, wherein an inner surface of the cap includes a recess for receiving the at least one pin magnet when the at least one pin magnet is in the locked configuration.

11. A writing instrument comprising:
a barrel body, the barrel body having a nose section;
a barrel magnet disposed proximate the nose section;
a cap releasably attached to the nose section, the cap having a cap opening at one end;
a plurality of cap magnets disposed within the cap, proximate the opening, the plurality of cap magnets being pivotable in an inner radial direction relative to the cap; and
a locking mechanism operatively attached to at least one cap magnet,
wherein the barrel magnet and the plurality of cap magnets are magnetically attracted to one another to produce both a longitudinal force that urges the cap in a longitudinal direction along a longitudinal axis of the barrel body towards the nose section, and a radial twisting force that urges the cap to twist to a locked position, and
wherein the cap magnets are attracted to the barrel magnet when the cap magnets are oriented in a locked position, which causes the cap magnets to pivot radially inward to a locked configuration and the cap magnets are repelled from the barrel magnet when the cap magnets are oriented in a released position, which causes the cap magnets to pivot radially outward to an unlocked retracted configuration.

12. The writing instrument of claim 11, wherein the plurality of cap magnets includes four cap magnets.

13. The writing instrument of claim 11, wherein each cap magnet is magnetically oriented opposite of adjacent cap magnets in the plurality of cap magnets.

14. The writing instrument of claim 11, wherein the barrel magnet is a ring magnet having two north poles located circumferentially opposite of one another and two south poles located circumferentially opposite of one another.

15. The writing instrument of claim 11, wherein the locking mechanism is a clasp.

16. The writing instrument of claim 11, wherein the barrel includes a recess proximate the nose section, the recess being sized and shaped to receive a portion of the locking mechanism.

17. The writing instrument of claim 11, wherein at least one cap magnet is pivotably attached to the cap with a living hinge.

18. The writing instrument of claim 11, wherein the plurality of cap magnets is attached to the cap to form a four fingered collet.

19. The writing instrument of claim 18, wherein the four fingered collet comprises pressed steel.

20. The writing instrument of claim 11, wherein the cap includes a tip sealing bush at one end.

21. A writing instrument comprising:
a first component, the first component having a nose section;
a first magnet disposed proximate the nose section;
a second component releasably attached to the nose section, the second component having a cap opening at one end;
a second magnet disposed proximate the opening; and
a magnetically actuated locking mechanism operatively connected to one of the first component and the second component,
wherein the first magnet and the second magnet are magnetically attracted to one another to produce both a longitudinal force that urges the cap in a longitudinal direction along a longitudinal axis towards the nose section, and a radial twisting force that urges the second component to twist to a locked position relative to the first component, and
wherein the locking mechanism is magnetically engaged when the second magnet is oriented in the locked position, and the locking mechanism is magnetically disengaged when the second magnet is oriented in a released position.
